(19) United States
(12) Patent Application Publication
(10) Pub. No.: US 2003/0157973 A1
(43) Pub. Date: Aug. 21, 2003

(54) Easy to carry hands-free kit containing earpiece inside the carrying case

(76) Inventor: Sung Yeon Yang, Los Angeles, CA (US)

Correspondence Address: Eugene Oak, Ph. D., J. D., Patent Attorney, 610 S. Van Ness Ave., Los Angeles, CA, 90005, US

(21) Appl. No.: 10/075,905

(22) Filed: Feb. 15, 2002

(51) Int. Cl. H04M 1/00

(52) U.S. Cl. 455/569; 455/550

(57) ABSTRACT

A hands-free kit for cellular phones containing earpiece set installed inside a newly designed carrying case. The earpiece set of this invention is installed inside the cellular phone carrying case of this invention. The earpiece set consists of, including but not limited to, a microphone, an earpiece, electric wire and a mechanical spring winder. The hands-free kit of this invention consists of, including but not limited to, a plastic carrying case, an adaptor, and an earpiece set connected to an on/off switch via thin copper wires coated with flexible plastic. The earpiece set of this invention is coiled inside the cellular phone carrying case of this invention by a mechanical spring winder installed inside the case. One end of the earpiece set is connected to the on/off switch, which is connected with the cellular phone main body via the earphone jack. The other end of the earpiece set is exposed out of the spring winder. The earpiece is holding on the out side of earpiece hole, which is on the backside of the case, to sustain a strain of the wire connected to the spring winder. The earpiece and speaker are stretched out of the carrying case when the user uses the hands-free kit. When the user does not pull out the earpiece, the power is supplied only to the cellular phone. The hands-free kit of this invention is convenient to carry all set in one package.

This invention relates to an easy to carry hands-free talking kit for a cellular phone, containing earpiece set inside of the cellular phone carrying case.

### 1. FIELD OF THE INVENTION

A hands-free talking kit for a cellular phone consists of, including but not limited to, a cellular phone carrying case, an adaptor, and an earpiece set connected to an on/off switch with thin copper wires coated with flexible plastic, which are installed inside of the carrying case and connected to a cellular phone via an earphone jack.

### 2. DESCRIPTION OF THE PRIOR ARTS

U.S. Pat. No. 5,850,439 to Yang demonstrates a portable hands-free telephone converter that allows a user to speak on the telephone without using the hands to hold a handset. The set is exposed to out side of a telephone, not installed inside a carrying holder.

U.S. Pat. No. 6,308,074 Chandra, et al. discloses a tether less handset telephone with an earpiece connection port. The handset is small in size and has an internal antenna. Thus, the handset can easily be placed within the user's pocket. A belt carrier for use with the handset holds the handset upside-down with the connection port easily accessible. The handset is arranged so that it can be cradled within a base unit. Earpiece is not wrapped inside the case.

U.S. Pat. No. 6,320,959 to Crouch, et al. illustrates a hearing aid telephone interconnect system to permit hearing impaired persons to use conventional telephone instruments employing a T-couple adapted to hook over the ear of a user of a conventional behind-the-hear, in-the-ear, and eyeglass hearing aid of the type employing an input T-coil.

U.S. Pat. No. 6,108,566 to Albanese, et al. provides a telephone handset for permitting hands-free operation of in a vehicle. The device, having a base pivotally attached to the vehicle above the door opening on the driver's side and stored above the door opening when not in use.

U.S. Pat. No. 5,667,948 to Pierre and U.S. Pat. No. 3,667,569 to Mackey illustrate a hands-free cellular phone wearing on user's neck. U.S. Pat. Nos. 5,407,113; 5,528,689; 4,907,266; 4,754,484 and 4,090,042 illustrate hands-free set wearing on user's head.

All of the prior art illustrate hearing set installed out side of carrying holder.

### SUMMARY OF THE INVENTION

Therefore, it is the purpose of this invention to provide an easy to carry hands-free kit, containing earpiece set inside a cellular phone carrying case. The hands-free kit of this invention consists of including but not limited to a plastic carrying case, an adaptor, an earpiece set connected to an on/off switch by thin copper wires coated with flexible plastic. The earpiece set of this invention is small enough to be installed inside the cellular phone carrying case of this invention. The earpiece set consists of, including but not limited to, a microphone, an earpiece, electric wire and a mechanical spring winder. The earpiece set of this invention is coiled inside the cellular phone carrying case of this invention by a mechanical spring winder installed inside the case. One end of the earpiece set is connected to the on/off switch, which is connected to the cellular phone via the earphone jack. The other end of the earpiece set is exposed out of the spring winder. The earpiece is holding on the out side of earpiece hole on the back of the case sustaining a strain of the wire connected to spring winder. The earpiece and speaker are stretched out of the carrying case when the user uses the hands-free kit. When the user does not pull out the earpiece, the power supplied only to the cellular phone. The kit is convenient to carry all set in one package. The kit of this invention minimizes losing earpiece set.

### BRIEF DESCRIPTION OF THE DRAWINGS

FIG. 1 is a front view of the holding case without cellular phone.

FIG. 2 is a side view of the carrying holder.

FIG. 3 is a perspective view of the assembly of the spring winder.

FIG. 4 is a rear view of the carrying holder.

### DETAILED DESCRIPTION OF THE PREFERRED EMBODIMENTS

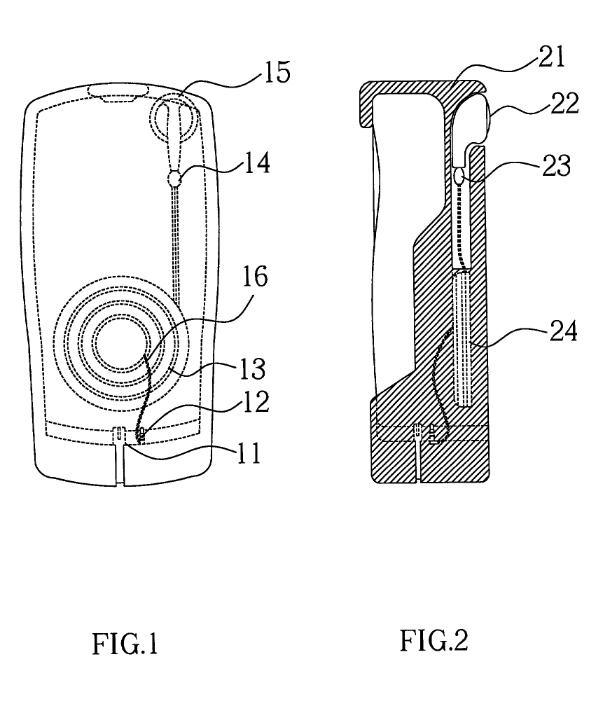

FIG. 1 is the front view of the cellular phone carrying case. Power is supplied to the phone through the adapter jack port (11). Voice signals are exchanged through the earpiece jack (12). The earpiece jack (12) is connected by a copper wire(16) to the ring connector (13). Dotted drawings (14) and (15) are microphone and earpiece, respectively.

FIG. 2 is the side view of the carrying case. The barrier (21) separates the cellular phone and hands-free kit. Earpiece (22) and microphone (23) are connected to the spring winder (24).

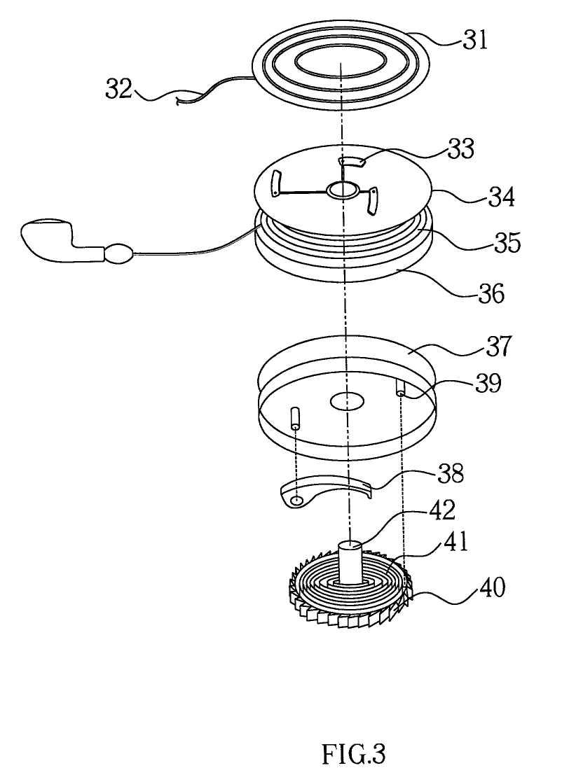

FIG. 3 is a perspective view of the assembly of the spring winder. Top element (31) is illustrated as (13) in FIG. 1. It consists of three copper rings separated by plastic and connected to cellular phone by wire (32). Each ring contacts with each copper knobs (33). The knobs are plated on plastic disc (34) and connected to the wire (35). The wire is wound on the winder (36). The winder is on the spring and gear box (37). In the gearbox, a cramp iron (38) is located on a rod to stop the gear (40) connected to the spring (41). The other end of the spring is fixed the other rod (39) in the gear box. When a user pulls out the earpiece (22) of FIG. 1, the wire (35) turns the center rod (42). Then the spring, connected to the rods, turns to the anti-clock wise and renders tension to the wire (35).

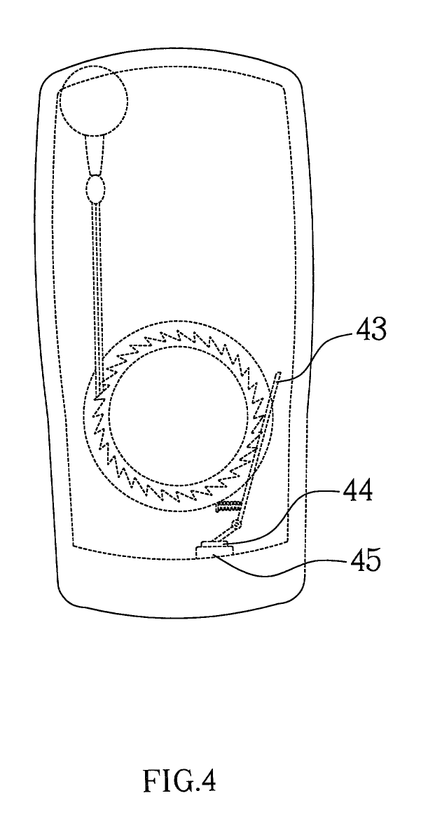

FIG. 4 is the rear view of the carrying case. As a user stretches out the earpiece, the radius of circle of wire bundle is reduced. Then the switch connector (43), supported on the surface of wire bundle, moves to the inner circle wise drawn by the coil spring (44) to turn on the switch (45). The cellular phone and earpiece are connected while the cellular phone is hanged on a user's pocket or waistband. The earpiece turns off when the user pulls out a little more of the ear piece and let the spring (41) wind the wire (35) and push the connector (43) clock wise and so the switch (45) are disconnected with the cellular phone. Mean while the cellular phone itself is not turned off.

What is claimed is:

1. A hands-free cellular phone talking kit consists of a plastic carrying case, an adaptor, and an earpiece set connected to an on/off switch with thin copper wires coated with flexible plastic.

2. The earpiece set in claim 1 consists of an earpiece, a microphone, electric wire and a mechanical spring winder.

3. One end of the earpiece set in claim 1 is connected to the cellular phone's ear piece jack, meanwhile, the other end, the ear piece and the microphone, is exposed out of the spring winder.

4. The earpiece set in claim 1 is small enough to be installed inside a cellular phone carrying case of this invention.

5. The earpiece in claim 1 is held on the outer surface of the earpiece hole to sustain strain of the wire connected to a spring winder.

6. The earpiece and speaker in claim 1 are stretched out of the carrying case when a human uses the hands -free kit.

7. The on/off switch in claim 1 is turned on when a user pull out the earpiece from the carrying case.

8. The on/off switch in claim 1 is turned off when a user pulls out the ear piece a little bit and release the ear piece to be rewind.
